(19) United States
(12) Patent Application Publication
(10) Pub. No.: US 2026/0134124 A1
(43) Pub. Date: May 14, 2026

(54) SYSTEMS AND METHODS FOR PROVIDING SECURE ACCESS TO DIGITAL ASSETS

(71) Applicant: Book.io, Inc., McKinney, TX (US)

(72) Inventor: Joshua Lee STONE, McKinney, TX (US)

(73) Assignee: Book.io, Inc., McKinney, TX (US)

(21) Appl. No.: 19/300,663

(22) Filed: Aug. 14, 2025

Related U.S. Application Data
(63) Continuation of application No. 18/058,714, filed on Nov. 23, 2022, now abandoned.
(60) Provisional application No. 63/361,103, filed on Nov. 23, 2021.

(51) Int. Cl. G06F 21/62; G06F 21/10; G06F 21/60; H04L 67/06; H04L 67/104

(52) U.S. Cl. CPC G06F 21/6209; G06F 21/10; G06F 21/602; H04L 67/06; H04L 67/104

(57) ABSTRACT

One embodiment is directed to a system for providing secure access to a digital asset, comprising a computing device configured to divide the digital asset into a plurality of portions and to encrypt each of the portions in the plurality using an asset key such that they may be stored on a decentralized peer-to-peer file sharing system; the computing device may be configured to create a manifest document based upon the division of the digital asset and storage of the portions thereof on the decentralized peer-to-peer file sharing system, such that given the access key and the manifest document, the digital asset may be securely reassembled by a user operating a client computing system.

### CROSS-REFERENCE TO RELATED APPLICATIONS

This application is a continuation of U.S. Provisional patent application Ser. No. 18/058,714, filed on Nov. 23, 2023, which claims priority to U.S. Provisional Patent Application Ser. No. 63/361,103 and filed on Nov. 23, 2021, which are incorporated by reference herein in its entirety.

### FIELD OF THE INVENTION

This group of systems, methods, and configurations relates generally to techniques for securely managing and distributing digital rights of various types, such as rights to textual digital assets such as books, rights to graphic or artistic visual digital works, such as photographs or paintings, rights to audio-based digital works, such as music or audio book recordings, and/or rights to audio-video digital works, such as recordings of stage performances, movies, or television media. More particularly the embodiments herein relate to various configurations of decentralized peer-to-peer file sharing systems for digital rights management, such as blockchain-based persistent file sharing systems.

### BACKGROUND

Computing and the use of digital rights has become ubiquitous in modern life. A typical person, whether for personal, social, and/or professional reasons, has relatively immediate access to computing systems of various types, including but not limited to systems or devices such as smartphones, tablet computers, laptop computers, desktop computers, terminals or access points to other computers, wearable computing systems such as smart watches, and voice-based computing systems such as those available from Amazon® under the tradename Alexa®. Such systems may be utilized to access and utilize certain digital rights. For example, millions of people consume audio digital rights using smartphone based players through services such as Apple Music® or Spotify®. Similarly, millions of people consume audio-video digital rights using tablet computers or laptops through services such as Netflix® or Hulu®, and/or textual digital assets, such as electronic books (or “e-books”) using handheld digital readers such as the Kindle®. As the world continues to accelerate adoption of digital rights utilization, there is a continued need for evolution of systems to facilitate efficient, secure, low-latency management, storage, and distribution systems for such digital rights. Presented herein are various configurations for addressing this challenge by utilizing various aspects of encryption and decentralized peer-to-peer file sharing systems, such as those which are persistent, immutable, and robust, and which may be blockchain-based.

### BRIEF DESCRIPTION OF THE DRAWINGS

FIG. 1 illustrates a flow configuration pertaining to aspects of an environment for implementing the novel digital media identification system (“MIS”).

FIG. 2 illustrates a flow chart associated with the MIS configuration of FIG. 1.

FIG. 3A illustrates a block diagram pertaining to an alternative configuration of an MIS used in conjunction with a media validation system.

FIG. 3B illustrates a block diagram pertaining to an alternative configuration of an MIS used in conjunction with a media access system.

FIG. 3C illustrates a block diagram pertaining to an alternative configuration of an MIS used in conjunction with a media validation system and a media access system.

FIG. 4 illustrates a flow chart associated with the configurations of FIGS. 3B and 3C.

FIG. 5 illustrates aspects of a media access system flow configuration.

FIGS. 6A-6C illustrate portions of a single block diagram (70) of an alternative implementation of the MIS when utilized in connection with books as digital media.

FIGS. 7A and 7B illustrate various aspects of alternative implementations of MIS used in connection with books as digital media.

FIGS. 8A-8C illustrate various aspects of additional implementations of MIS configurations used in connection with print digital bundles as digital assets.

FIG. 9 illustrates a high-level flow pertaining to a user working within an access marketplace for digital rights.

FIG. 10 illustrates a flow chart configuration pertaining to a user working within an access marketplace for digital rights.

FIG. 11 illustrates a flow chart configuration pertaining to a secure digital rights management configuration utilizing a decentralized storage system.

FIG. 12A illustrates aspects of a configuration for creating and securely storing a decentralized encrypted asset (“DEA”).

FIG. 12B illustrates aspects of a configuration for acquiring rights to and utilizing a decentralized encrypted asset.

### SUMMARY

One embodiment is directed to a system for providing secure access to a digital asset, comprising a computing device configured to divide the digital asset into a plurality of portions and to encrypt each of the portions in the plurality using an asset key such that they may be stored on a decentralized peer-to-peer file sharing system; the computing device may be configured to create a manifest document based upon the division of the digital asset and storage of the portions thereof on the decentralized peer-to-peer file sharing system, such that given the access key and the manifest document, the digital asset may be securely reassembled by a user operating a client computing system. The computing device may be configured to divide the digital asset into a plurality of portions based upon a predetermined portion size. The computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for accessing a digital asset, comprising a client computing system operable by a user; and a decentralized peer-to-peer file sharing system operatively coupled to the client computing system and configured to facilitate assembly and use of a digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the digital asset may be securely reassembled by the client computing system for usage by the user. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for providing secure access to a digital asset, comprising a decentralized peer-to-peer file sharing system operatively coupled to a client computing system and configured to facilitate assembly and use of a digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the digital asset may be securely reassembled by the client computing system operated by a user. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for reading a textual digital asset, comprising: a client computing system local to a user and configured to display a graphical user interface configured to facilitate reading of one or more textual features of the digital asset; and a decentralized peer-to-peer file sharing system operatively coupled to the client computing system and configured to facilitate assembly and use of the textual digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the textual digital asset may be securely reassembled by the client computing system operated by the user such that the user may sequence through the one or more textual features of the textual digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the textual digital asset into a plurality of portions based upon a predetermined portion size. A computing device may be configured to automatically divide the textual digital asset into a plurality of portions. A computing device may be configured to divide the textual digital asset into a plurality of portions based upon chapters in the textual digital asset created by an author of the textual digital asset. The computing device may be configured to divide the textual digital asset by chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for reading an artistic visual digital asset, comprising a client computing system local to a user and configured to display a graphical user interface configured to facilitate viewing of one or more artistic visual features of the artistic visual digital asset; and a decentralized peer-to-peer file sharing system operatively coupled to the client computing system and configured to facilitate assembly and use of the artistic visual digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the artistic visual digital asset may be securely reassembled by the client computing system operated by the user such that the user may display and view the one or more artistic features of the artistic visual digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the artistic visual digital asset into a plurality of portions based upon a predetermined portion size. A computing device may be configured to automatically divide the artistic visual digital asset into a plurality of portions. A computing device may be configured to divide the artistic visual digital asset into a plurality of portions based upon adjacent spatial portions of the artistic visual digital asset created by an author of the artistic visual digital asset. The artistic visual digital asset may be a two-dimensional image defining an image area, and wherein the computing device is configured to divide the artistic visual digital asset based upon sub-portions of the image area. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for playing an audio digital asset, comprising: a client computing system local to a user and configured to display a graphical user interface configured to facilitate viewing of one or more audio features of the audio digital asset; and a decentralized peer-to-peer file sharing system operatively coupled to the client computing system and configured to facilitate assembly and use of the audio digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the audio digital asset may be securely reassembled by the client computing system operated by the user such that the user may play the one or more audio features of the audio digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the audio digital asset into a plurality of portions based upon a predetermined portion size. A computing device may be configured to automatically divide the audio digital asset into a plurality of portions. A computing device may be configured to divide the audio digital asset into a plurality of portions based upon adjacent time-sequential portions of the audio digital asset created by an author of the audio digital asset. The audio digital asset may be a plurality of musical recordings, and wherein the computing device is configured to divide the audio digital asset based upon sequential breaks between the musical recordings. The audio digital asset may be a plurality of chapters of a written work read and recorded by a speaker, and wherein the computing device is configured to divide the audio digital asset based upon sequential breaks between the chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for playing an audio-video digital asset, comprising: a client computing system local to a user and configured to display a graphical user interface configured to facilitate viewing of one or more audio-video features of the audio-video digital asset; and a decentralized peer-to-peer file sharing system operatively coupled to the client computing system and configured to facilitate assembly and use of the audio-video digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the audio-video digital asset may be securely reassembled by the client computing system operated by the user such that the user may play the one or more audio-video features of the audio-video digital asset. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the audio-video digital asset into a plurality of portions based upon a predetermined portion size. A computing device may be configured to automatically divide the audio-video digital asset into a plurality of portions. A computing device may be configured to divide the audio-video digital asset into a plurality of portions based upon adjacent time-sequential portions of the audio-video digital asset created by an author of the audio-video digital asset. The audio digital asset may be a sequence of a plurality of audio-video recordings, and wherein the computing device is configured to divide the audio-video digital asset based upon sequential breaks between one or more of the plurality of audio-video recordings. The audio-video digital asset may be a plurality of chapters of a recorded audio-video work, and wherein the computing device is configured to divide the audio-video digital asset based upon sequential breaks between the chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a secure system for providing limited access to purchasing interface, comprising a client computing system local to a user and configured to display a graphical user interface configured to facilitate operation of a purchasing digital asset; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, the purchasing digital asset may be securely reassembled by the client computing system operated by the user such that the user may operate the purchasing digital asset to consummate a purchase which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the purchasing digital asset into a plurality of portions based upon a predetermined portion size. A computing device may be configured to automatically divide the purchasing digital asset into a plurality of portions. The purchasing digital asset may comprise a purchasing graphical user interface comprising an order and payment configuration. The purchasing digital asset may comprise an event ticket purchasing interface. The purchasing digital asset may comprise a limited-quantity-goods/services purchasing interface. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted. The purchasing digital asset may be securely reassembled by the client computing system operated by the user only subsequent to presentation of both the asset key and the manifest document.

Another embodiment is directed to a secure system for providing limited access to a digital asset, comprising a client computing system local to a user and configured to display a graphical user interface configured to facilitate utilization of a digital asset after successfully meeting a pre-established condition precedent; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, and the manifest document, and upon confirmation that the pre-established condition precedent has been met, the digital asset may be securely reassembled by the client computing system operated by the user such that the user may operate the graphical user interface to utilize the digital asset, which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may comprise a limited-access artistic image. The digital asset may comprise a limited-access video recording. The digital asset may comprise a limited-access audio recording. The digital asset may be customized for the user. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a secure system for providing location-based limited access to a digital asset, comprising a client computing system local to a user in a user location and configured to display a graphical user interface configured to facilitate utilization of a digital asset; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the user location, the digital asset may be securely reassembled by the client computing system operated by the user in a delivery configuration based at least in part upon the user location. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. Information pertaining to the user location may be selected from the group consisting of: client computing system localization information; user address location information; and user-volunteered location information. Information pertaining to the user location may comprise client computing system localization information determined, based at least in part, upon an input from the group consisting of: GPS information; network triangulation information; network address information; and wireless transceiver triangulation information. The digital asset may be securely reassembled by the client computing system operated by the user in a delivery configuration in a specific form based upon the user location. The digital asset may be securely reassembled by the client computing system operated by the user in a delivery configuration with specific content based upon the user location. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a secure system for providing connectivity-based limited access to a digital asset, comprising a client computing system local to a user in a user location and configured to display a graphical user interface configured to facilitate utilization of a digital asset through a network connection; and a decentralized peer-to-peer file sharing system operatively coupled to the client computing system through the network connection and configured to facilitate assembly and use of the digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the quality of the network connection, the digital asset may be securely reassembled by the client computing system operated by the user in a delivery configuration based at least in part upon the quality of the network connection. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The quality of the network connection may be determined based at least in part upon an input from the group consisting of: a network latency determination; a packet loss determination; a bandwidth determination; a network route-trace determination, and a signal strength determination. The quality of the network connection may be determined using an automated testing paradigm during at least a portion of the time during which the client computing system is operatively coupled to the decentralized peer-to-peer file sharing system. The digital asset may be securely reassembled by the client computing system operated by the user in a delivery configuration utilizing a digital asset resolution that is dynamic to the quality of the network connection. The digital asset may be securely reassembled by the client computing system operated by the user in a delivery configuration utilizing a digital asset transmission rate that is dynamic to the quality of the network connection. The digital asset may be securely reassembled by the client computing system operated by the user in a delivery configuration utilizing a digital asset buffering configuration that is dynamic to the quality of the network connection. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a system for providing secure access to a digital asset, comprising a computing device configured to encrypt the digital asset using an asset key and store the encrypted digital asset on a decentralized peer-to-peer file sharing system, such that given the access key, the digital asset may be securely reassembled by a user operating a client computing system. The computing device may be further configured to create an encrypted version the asset key, and to store the encrypted asset key on the decentralized peer-to-peer file sharing system. The encrypted version of the asset key may be created using a publication key. The digital asset may be a textual digital asset. The textual digital asset may be an electronic copy of a printed publication. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system.

Another embodiment is directed to a method for providing secure access to a digital asset, comprising providing a computing device configured to divide the digital asset into a plurality of portions and to encrypt each of the portions in the plurality using an asset key such that they may be stored on a decentralized peer-to-peer file sharing system; wherein the computing device is configured to create a manifest document based upon the division of the digital asset and storage of the portions thereof on the decentralized peer-to-peer file sharing system, such that given the asset key and the manifest document, the digital asset may be securely reassembled by a user operating a client computing system. The computing device may be configured to divide the digital asset into a plurality of portions based upon a predetermined portion size. The computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for accessing a digital asset, comprising providing a client computing system operable by a user; and operatively coupling the client computing system to a decentralized peer-to-peer file sharing system configured to facilitate assembly and use of a digital asset which has undergone a sequence of division into portions, encryption of each of the portions using an asset key, storage of the portions on the peer-to-peer file sharing system after encryption, and creation of a manifest document based upon the division, encryption, and storage, such that upon presentation of the asset key and the manifest document, the digital asset may be securely reassembled by the client computing system for usage by the user. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for providing secure access to a digital asset, comprising providing a decentralized peer-to-peer file sharing system operatively coupled to a client computing system and configured to facilitate assembly and use of a digital asset which has undergone a sequence of division into portions, encryption of each of the portions using an asset key, storage of the portions on the peer-to-peer file sharing system after encryption, and creation of a manifest document based upon the division, encryption, and storage; such that upon presentation of the asset key and the manifest document, the digital asset may be securely reassembled by the client computing system operated by a user. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may be a textual digital asset. The computing device may be configured to divide the digital asset into a plurality of portions based upon chapters in the textual digital asset created by an author of the textual digital asset. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for reading a textual digital asset, comprising providing a client computing system local to a user and configured to display a graphical user interface configured to facilitate reading of one or more textual features of the digital asset; and operatively coupling the client computing system to a decentralized peer-to-peer file sharing system configured to facilitate assembly and use of the textual digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the textual digital asset may be securely reassembled by the client computing system operated by the user such that the user may sequence through the one or more textual features of the textual digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the textual digital asset into a plurality of portions based upon a predetermined portion size. A computing device may be configured to automatically divide the textual digital asset into a plurality of portions. A computing device may be configured to divide the textual digital asset into a plurality of portions based upon chapters in the textual digital asset created by an author of the textual digital asset. The computing device may be configured to divide the textual digital asset by chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for reading an artistic visual digital asset, comprising: providing a client computing system local to a user and configured to display a graphical user interface configured to facilitate viewing of one or more artistic visual features of the artistic visual digital asset; and operatively coupling the client computing system with a decentralized peer-to-peer file sharing system configured to facilitate assembly and use of the artistic visual digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the artistic visual digital asset may be securely reassembled by the client computing system operated by the user such that the user may display and view the one or more artistic features of the artistic visual digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the artistic visual digital asset into a plurality of portions based upon a predetermined portion size. A computing device may be configured to automatically divide the artistic visual digital asset into a plurality of portions. A computing device may be configured to divide the artistic visual digital asset into a plurality of portions based upon adjacent spatial portions of the artistic visual digital asset created by an author of the artistic visual digital asset. The artistic visual digital asset may be a two-dimensional image defining an image area, and wherein the computing device is configured to divide the artistic visual digital asset based upon sub-portions of the image area. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for playing an audio digital asset, comprising providing a client computing system local to a user and configured to display a graphical user interface configured to facilitate viewing of one or more audio features of the audio digital asset; and operatively coupling the client computing system to a decentralized peer-to-peer file sharing system configured to facilitate assembly and use of the audio digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the audio digital asset may be securely reassembled by the client computing system operated by the user such that the user may play the one or more audio features of the audio digital asset. The client computing system may comprise a personal computing device. The personal computing device may be selected from the group consisting of: a smartphone, a personal computer, a tablet, a media reader, and a smart watch. The client computing system may be operatively coupled to the decentralized peer-to-peer file sharing system using a network connection. The network connection may be a wired or wireless network connection. A computing device may be configured to divide the audio digital asset into a plurality of portions based upon a predetermined portion size. A computing device may be configured to automatically divide the audio digital asset into a plurality of portions. A computing device may be configured to divide the audio digital asset into a plurality of portions based upon adjacent time-sequential portions of the audio digital asset created by an author of the audio digital asset. The audio digital asset may be a plurality of musical recordings, and wherein the computing device is configured to divide the audio digital asset based upon sequential breaks between the musical recordings. The audio digital asset may be a plurality of chapters of a written work read and recorded by a speaker, and wherein the computing device is configured to divide the audio digital asset based upon sequential breaks between the chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for playing an audio-video digital asset, comprising providing a client computing system local to a user and configured to display a graphical user interface configured to facilitate viewing of one or more audio-video features of the audio-video digital asset; and operatively coupling the client computing system with a decentralized peer-to-peer file sharing system configured to facilitate assembly and use of the audio-video digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, the audio-video digital asset may be securely reassembled by the client computing system operated by the user such that the user may play the one or more audio-video features of the audio-video digital asset. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the audio-video digital asset into a plurality of portions based upon a predetermined portion size. A computing device may be configured to automatically divide the audio-video digital asset into a plurality of portions. A computing device may be configured to divide the audio-video digital asset into a plurality of portions based upon adjacent time-sequential portions of the audio-video digital asset created by an author of the audio-video digital asset. The audio digital asset may be a sequence of a plurality of audio-video recordings, and wherein the computing device is configured to divide the audio-video digital asset based upon sequential breaks between one or more of the plurality of audio-video recordings. The audio-video digital asset may be a plurality of chapters of a recorded audio-video work, and wherein the computing device is configured to divide the audio-video digital asset based upon sequential breaks between the chapters. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted. Another embodiment is directed to a method for providing secure limited access to purchasing interface, comprising: providing a client computing system local to a user and configured to display a graphical user interface configured to facilitate operation of a purchasing digital asset; and operatively coupling the client computing system to a decentralized peer-to-peer file sharing system configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, the purchasing digital asset may be securely reassembled by the client computing system operated by the user such that the user may operate the purchasing digital asset to consummate a purchase which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the purchasing digital asset into a plurality of portions based upon a predetermined portion size. A computing device may be configured to automatically divide the purchasing digital asset into a plurality of portions. The purchasing digital asset may comprise a purchasing graphical user interface comprising an order and payment configuration. The purchasing digital asset may comprise an event ticket purchasing interface. The purchasing digital asset may comprise a limited-quantity-goods/services purchasing interface. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted. The purchasing digital asset may be securely reassembled by the client computing system operated by the user only subsequent to presentation of both the asset key and the manifest document.

Another embodiment is directed to a method for providing secure limited access to a digital asset, comprising providing a client computing system local to a user and configured to display a graphical user interface configured to facilitate utilization of a digital asset after successfully meeting a pre-established condition precedent; and operatively coupling the client computing system with a decentralized peer-to-peer file sharing system configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, and the manifest document, and upon confirmation that the pre-established condition precedent has been met, the digital asset may be securely reassembled by the client computing system operated by the user such that the user may operate the graphical user interface to utilize the digital asset, which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may comprise a limited-access artistic image. The digital asset may comprise a limited-access video recording. The digital asset may comprise a limited-access audio recording. The digital asset may be customized for the user. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for securely providing location-based limited access to a digital asset, comprising providing a client computing system local to a user in a user location and configured to display a graphical user interface configured to facilitate utilization of a digital asset; and operatively coupling the client computing system to a decentralized peer-to-peer file sharing system configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the user location, the digital asset may be securely reassembled by the client computing system operated by the user in a delivery configuration based at least in part upon the user location. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. Information pertaining to the user location may be selected from the group consisting of: client computing system localization information; user address location information; and user-volunteered location information. Information pertaining to the user location may comprise client computing system localization information determined, based at least in part, upon an input from the group consisting of: GPS information; network triangulation information; network address information; and wireless transceiver triangulation information. The digital asset may be securely reassembled by the client computing system operated by the user in a delivery configuration in a specific form based upon the user location. The digital asset may be securely reassembled by the client computing system operated by the user in a delivery configuration with specific content based upon the user location. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for securely providing connectivity-based limited access to a digital asset, comprising providing a client computing system local to a user in a user location and configured to display a graphical user interface configured to facilitate utilization of a digital asset through a network connection; and operatively coupling the client computing system with a decentralized peer-to-peer file sharing system through the network connection, the decentralized peer-to-peer file sharing system configured to facilitate assembly and use of the digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the quality of the network connection, the digital asset may be securely reassembled by the client computing system operated by the user in a delivery configuration based at least in part upon the quality of the network connection. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The quality of the network connection may be determined based at least in part upon an input from the group consisting of: a network latency determination; a packet loss determination; a bandwidth determination; a network route-trace determination, and a signal strength determination. The quality of the network connection may be determined using an automated testing paradigm during at least a portion of the time during which the client computing system is operatively coupled to the decentralized peer-to-peer file sharing system. The digital asset may be securely reassembled by the client computing system operated by the user in a delivery configuration utilizing a digital asset resolution that is dynamic to the quality of the network connection. The digital asset may be securely reassembled by the client computing system operated by the user in a delivery configuration utilizing a digital asset transmission rate that is dynamic to the quality of the network connection. The digital asset may be securely reassembled by the client computing system operated by the user in a delivery configuration utilizing a digital asset buffering configuration that is dynamic to the quality of the network connection. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a method for providing secure access to a digital asset, comprising encrypting the digital asset with a computing device using an asset key; and storing the encrypted digital asset on a decentralized peer-to-peer file sharing system, such that given the asset key, the digital asset may be securely reassembled by a user operating a client computing system. The method further may comprise creating an encrypted version the asset key, and storing the encrypted asset key on the decentralized peer-to-peer file sharing system. The encrypted version of the asset key may be created using a publication key. The digital asset may be a textual digital asset. The textual digital asset may be an electronic copy of a printed publication. The digital asset may be an artistic visual digital asset. The artistic visual digital asset may be selected from the group consisting of: a photograph; an image of a painting; an image of a drawing; and a synthetic image. The digital asset may be an audio digital asset. The audio digital asset may be selected from the group consisting of: a portion of a music recording; a portion of a voice recording; a portion of a synthetic audio recording; a portion of a sound track designed to accompany video; and a portion of a live audio recording. The digital asset may be an audio-video digital asset. The audio-video asset may be selected from the group consisting of: a portion of a movie recording; a portion of a television recording; and a portion of a synthetic audio-visual presentation. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system.

### DETAILED DESCRIPTION

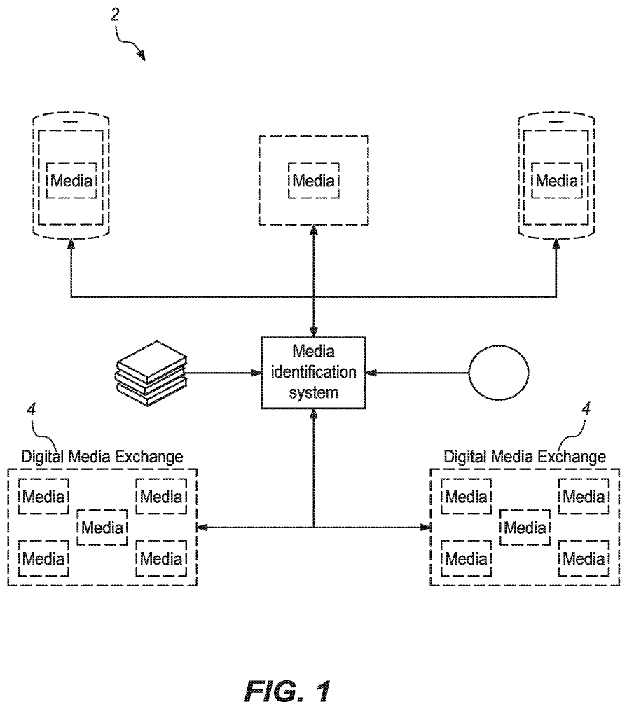

FIG. 1 is illustrates aspects of an environment for implementing the novel digital media identification system (“MIS” 2). This MIS may be used in conjunction with media for varying types, such as books, music, movies, as shown in FIG. 1. Regardless of the media type, the digital MIS (2) may be configured to create and store a unique digital media identifier of each individual media source that it receives. Utilizing this type of digital media identifier can aid with more efficient and safer storage of digital media, which also allows many other advantages, such as use in alternative environments like a digital marketplace.

Once created, the digital media identifier may be used in a host of environments. One such environment is a digital media exchange (4) where any number of media may be exchanged between people or companies. For example, a person (“Jane”) may no longer want to own the rights that she procured to the book “To Kill a Mockingbird,” and another person (“Jack”) may be looking for that very same book. In this example, the digital media exchange may help owners like Jane find interested individuals like Jack and facilitate the exchange of merchandise. Using the MIS, a unique digital identifier may be created for Jane's specific copy of the book, and that identifier may also indicate the current owner. When used in the context of a digital media exchange (4), the unique digital identifier would get updated after Jack became the owner of this copy of “To Kill a Mockingbird.” Now that such exchange has happened, the MIS can either remove Jane's access to the book from her computer and cellular phone, as illustrated in the configuration of FIG. 1. Similarly, the MIS may be used in providing access to the book on Jack's cellular phone, for example.

With advances in technology, there are an increasingly large numbers of users who have rights in digital content. The innovative MIS provides these users with one of the greatest advantages of ownership—the ability to resell. The digital book content with the MIS can be trackable and transferable in a decentralized ecosystem—which is significantly more secure than current Digital Rights Management standards. This system may be utilized to disrupt prior digital book business models, create a significant new secondary markets, and unlock new revenue opportunities for publishers and authors. “Smart contract” capabilities may be employed to create a new secondary market for electronic books (“eBooks”) and audiobooks, with authors and publishers earning royalties in perpetuity as readers consume, collect and trade books.

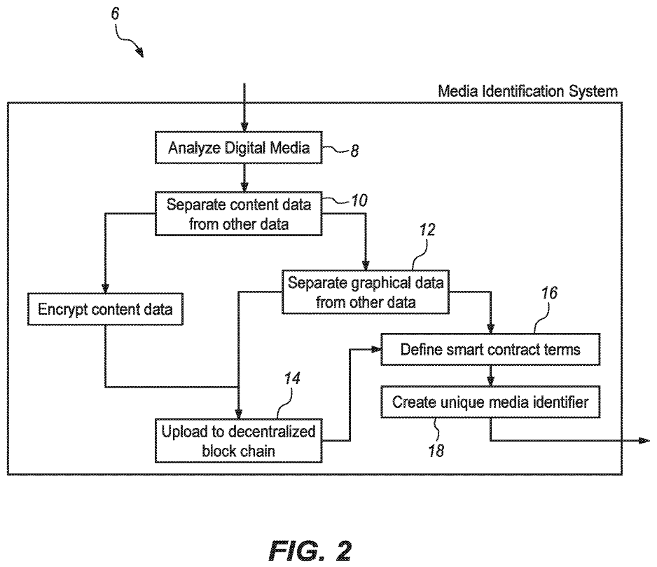

FIG. 2 illustrates a flow chart associated with the MIS of FIG. 1. The block in this flow chart may be completed by any one of a host of possible options, such as in a program written in a machine-readable language or using random access memory, programmable read only memory or the like. Moreover, the blocks may be implemented in a different order, and still fall within the context of the novel MIS. With that said, this description provides a discussion of the blocks illustrated in FIG. 2.

Thus referring again to FIG. 2, the MIS analyzes the digital media that it receives. As mentioned in the context of FIG. 1, the media may be associated with a book, music, movie or the like. For example, the media could be a book that is received in a known “.epub” format. Next, the MIS may be configured to separate content data associated with the received digital media from any other data. For example, the story contents may be separated from other data, like the author's name. In a decision block, the MIS may be configured to determine whether other data has been received, and may be configured to follow the “no” path when no other data has been received resulting in encrypting the media contents. After separating content data from other data (10), the MIS may be configured to separate graphical data from the nongraphical data (12). An example of graphical data may include an image of a book cover. The graphical data and the encrypted contents may be uploaded to decentralized peer-to-peer file sharing system, such as a blockchain file storage system (14), in this implementation, but other implementations may result from different kinds of file storage options. “Smart contract” terms may be defined (16) and a unique digital identifier may be subsequently created (18). In short, the MIS may be configured to receive digital media, encrypt the contents, upload the encrypted contents along with any graphical data to the block chain, and create a unique digital identifier for all the media it received.

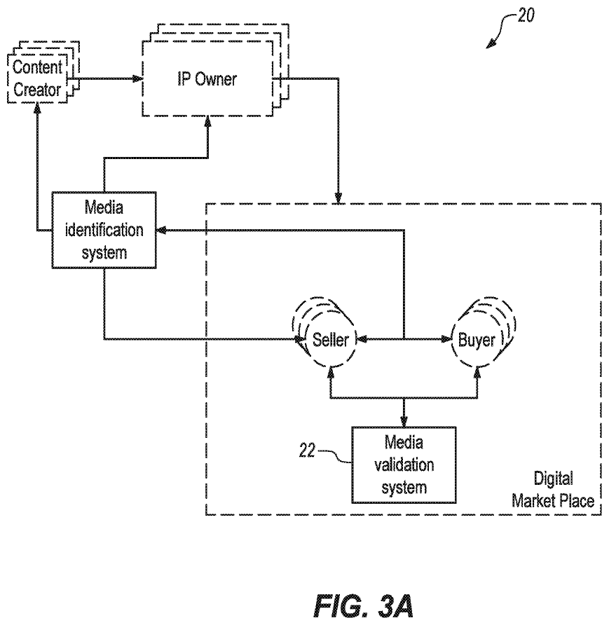

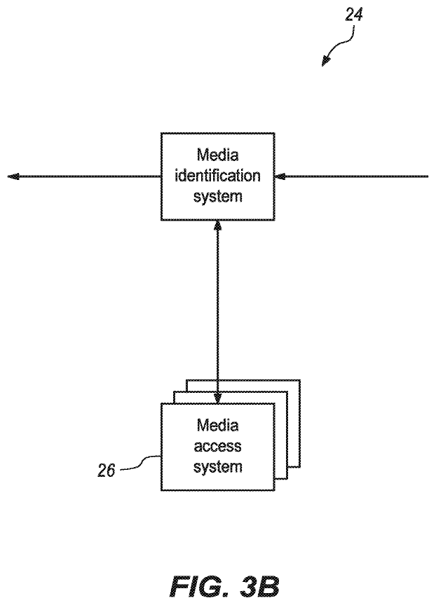

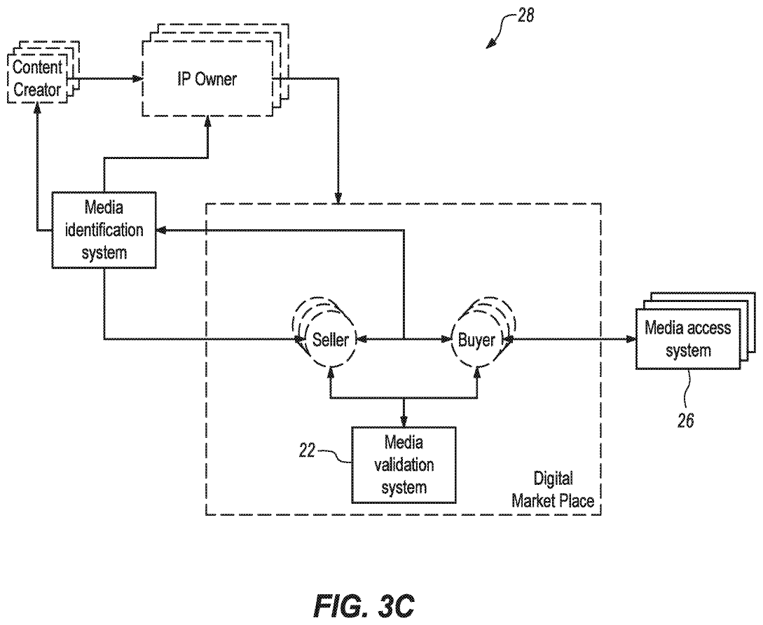

Referring to FIG. 3A, a block diagram (20) is illustrated pertaining to a first alternative implementation of the MIS of FIG. 2 used in conjunction with a media validation system. In this implementation, the digital media exchange of FIG. 1 is a digital marketplace where buyers are interested in purchasing digital media from sellers. For example, an author (content creator) can write a book that he sends to a publisher (IP owner) who publishes a book that her company offers for sale within the digital marketplace. Since the MIS may be configured to create a unique identifier for this book, the media validation system (22) can provide validation of the book's availability for purchase, change in ownership, and received payment. The MIS can update the content creator and intellectual property (“IP”) owner of the occurring transaction, including any financial remuneration associated with it: While this example describes a publisher as a seller in the marketplace, an alternative implementation may result if the content creator is also the intellectual property controller or owner, which would happen when a person self-publishes a book. In addition, the digital marketplace allows buyers to become sellers and vice versa making it easy for buyers to sell to other buyers or sellers.

FIG. 3B illustrates a block diagram pertaining to a second alternative implementation of the MIS of FIG. 2 used in conjunction with a media access system (26). The media access system may be housed inside a smart device, such as a cellular phone, tablet, computer, hot storage, or cold storage. Each of the media, such as books, music, or movies, stored on the smart device may be assigned a unique digital identifier by the MIS, as described with reference to FIG. 2. With this identifier, the MIS may be configured to either permit or restrict access to the media stored on the device. For example, the MIS may be configured to restrict access to a movie previously stored on the device that was recently purchased by a buyer through the digital exchange. However, the MIS may be configured to continue permitting access to a book stored on the device, which has not been purchased by a buyer. In this way, the content on the smart device may generally remain reflective of the content a user currently owns.

FIG. 3C illustrates a block diagram of a third alternative configuration (28) of the MIS used in conjunction with a media validation system (22) and a media access system (26). While this implementation is similar to the implementations described in FIGS. 3A-3B, the media access system can provide access to the media the buyer purchased and remove the seller's access to the media in light of the transactions occurring in the digital marketplace. By creating a MIS that works in conjunction with the media validation system and the media access system using decentralized file storage, it allows a more robust and efficient manner for media to be exchanged without some of the safety concerns, such as so-called “hackability”. In addition, the MIS may be configured to utilize a “smart contract” feature enabling unlocking of longform media on a user's device, and directing of fees associated with sales in a digital marketplace.

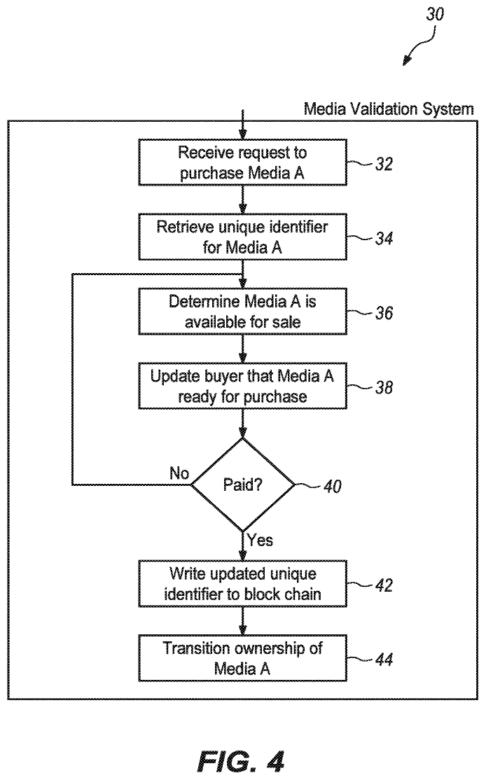

FIG. 4 illustrates a flow chart for associated with the media validation system of FIGS. 3B-3C. The block in this flow chart may be completed by any one of a host of possible options, such as a program written in a machine-readable language or using random access memory, programmable read only memory or the like. Moreover, the blocks may be implemented in a different order, and still fall within the context of the novel MIS. With that said, this description provides a discussion of the blocks illustrated in FIG. 4.

Thus referring to FIG. 4, the media validation system receives a request to purchase media, such as “Media A” (32). For example, this request could come from a buyer through the digital marketplace of FIG. 3A. In response, the media validation system may be configured to retrieve the unique digital identifier associated with Media A (34) and determine whether this piece of media is available for sale (36). When Media A is available for sale, the media validation system may be configured to update the potential buyer of its availability for sale (38), and then determine whether the buyer has paid (40) for Media A. If a buyer has not paid for it, the “no” path may be followed returning to the block where Media A's availability for sale is determined. Otherwise, the “yes” path may be followed, and the updated unique digital identifier is written to the blockchain (42). The ownership of Media A is then transferred (44).

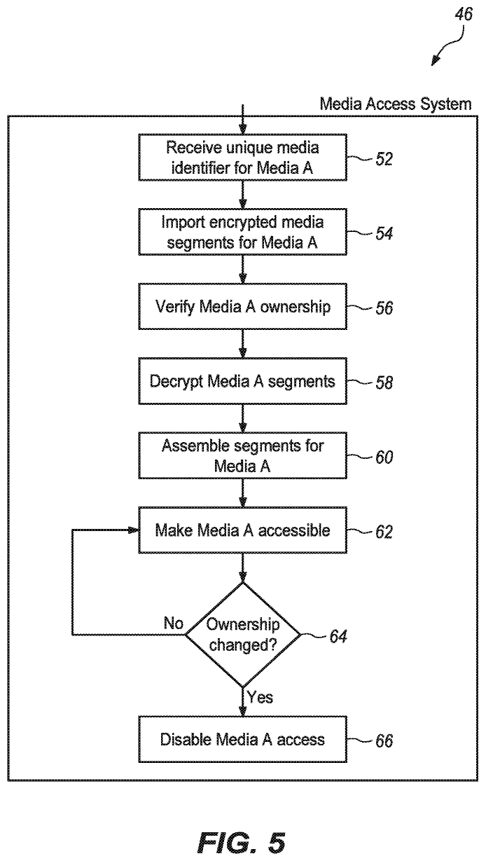

FIG. 5 illustrates a flow chart associated with the media access system of FIGS. 3B-3C. The block in this flow chart may be completed by any one of a host of possible options, such as a program written in a machine-readable language or using random access memory, programmable read only memory or the like. Moreover, the blocks may be implemented in a different order, and still fall within the context of the novel MIS. With that said, this description provides a discussion of the blocks illustrated in FIG. 5.

Referring to FIG. 5, the media access system may be configured to receive the unique digital identifier associated with “Media A” (52), which is merely illustrative of a unique digital identifier associated with a specific media. Having received the unique identifier, the media access system may be configured to retrieve the encrypted media segments (54) stored on a decentralized storage system such as a blockchain based peer-to-peer file sharing system, and verify the ownership of Media A (56). If the media access system confirms that the ownership of Media A is the owner of the smart device requesting Media A, then the media access system may be configured to decrypt (58) and subsequently assemble (60) the media segments making media A accessible (62) to the owner of the smart device. In addition, the media access system may be configured to confirm regular checks assessing whether the ownership of Media A has changed (64), and either continue making the media accessible or disable accessibility as appropriate (66).

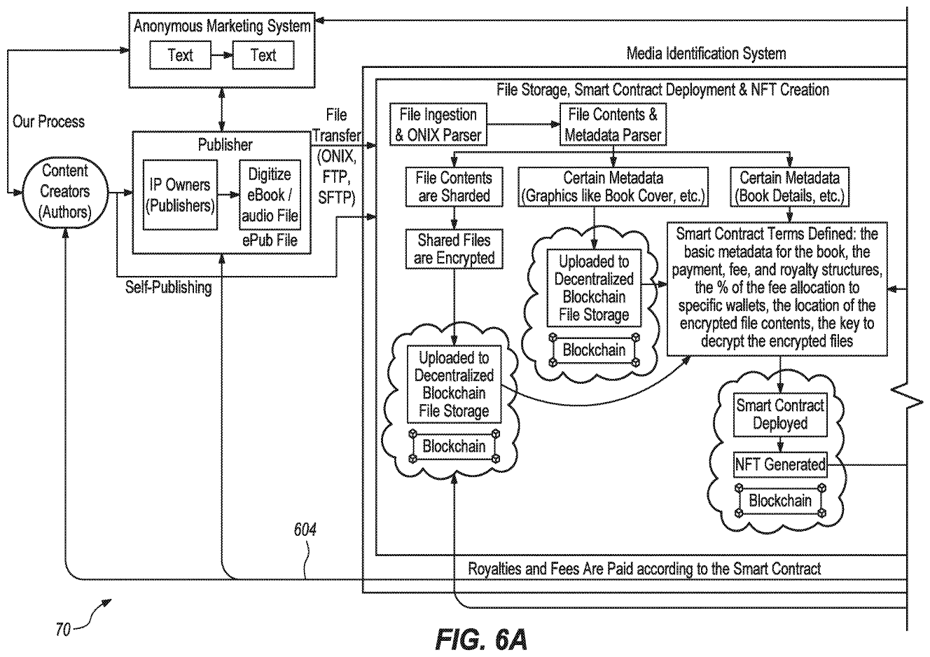

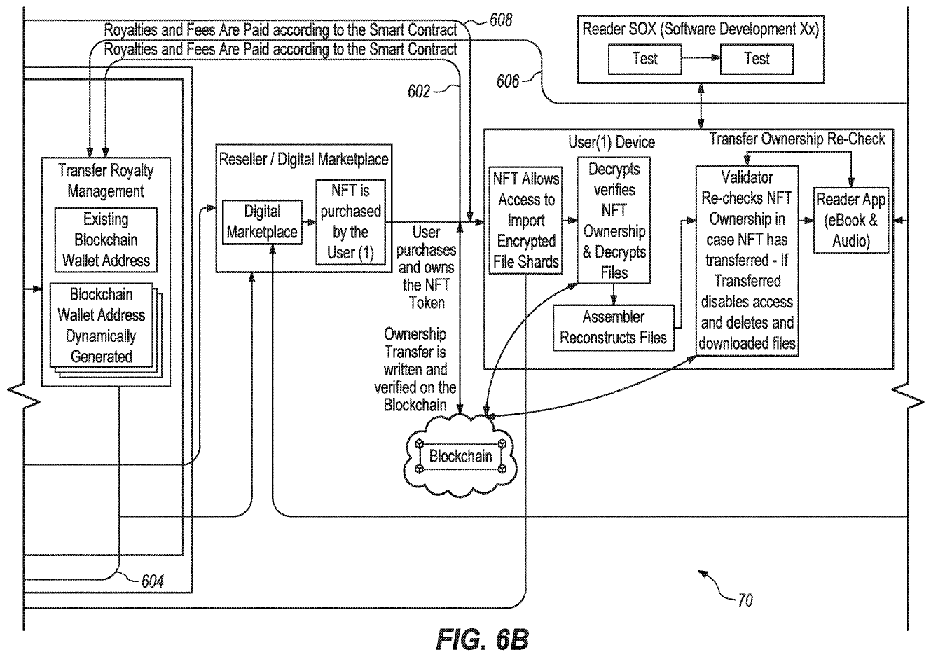

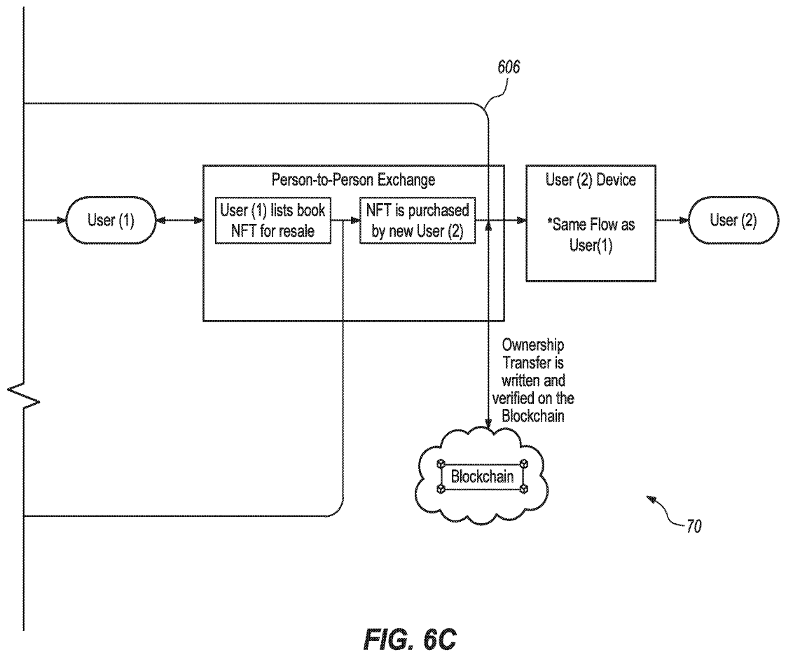

FIGS. 6A-6C illustrate portions of a single block diagram (70) of a fourth alternative implementation of the MIS when utilized in connection with books. In this implementation, a creator of a book can either self-publish or use a publisher resulting in the creation of a digitized file of the book in a form, such as that known as “ONIX”. That digitized file may be parsed out further between the contents and the metadata. Starting on the left of FIG. 6A, all the file contents may be broken into pieces, encrypted, and then put into a decentralized storage system, such as a blockchain-based peer-to-peer file sharing system. The system may be configured such that this process generally may be done first, so the location of the linkable content files are known. Then, the metadata of the graphics may be uploaded to a blockchain-based storage system as well with a link to those content assets. Other book details such as the author, publisher, dates, may comprise the relevant content shown as “certain metadata.” The system may be configured such that all of these events culminate into creating the terms of a smart contract for the metadata including the payment, fees, and the royalty structure associated with the publishers and content creators.

To facilitate payment, the MIS may be configured to utilize an existing blockchain-based electronic “wallet” address configured to pay as shown with transitive royalty boxes (see, for example, FIG. 6B). These boxes can be dynamically created as needed to store for a particular book or publish content. With the smart contract, the MIS may specify the percentage of fees allocated to different wallets; capture the location of all the encrypted files; and collect the key to decrypt these files later. All of this may be deployed as a “smart contract” and be configured to generate a nonfungible token (“NFT”; a unique digital object with a unique digital identifier). The system may be configured such that the NFT goes over to a separate block labeled “resellers/digital marketplace” on FIG. 6B. The illustrative MIS may be a pipeline where NFTs are generated, so that other resellers can resell books using a more secure file transfer system that includes inventory management. For example, an alternative implementation can result from the MIS generating NFTs that other resellers use in their own digital marketplaces.

In the digital marketplace illustrated in FIG. 6B, a user may purchase an NFT denoted as “User(1)” enabling distinction between it and another user. When the user purchases it, then line 602 is followed and royalties and fees may be determined by analyzing the smart contract, which is conducted by the MIS. Once the fees associated with smart contract are identified, line 604 (see FIG. 6B) may be followed from the MIS to the reseller/digital marketplace to the publisher and content creator (see FIG. 6A). In this manner, the associated parties may be paid according to the contract at essentially same time. Then, the ownership may be transferred and written to the blockchain-based storage configuration so that it is known that the pertinent unique digital identifier, or NFT, has moved to a different wallet because ownership has changed. The NFT allows importation of encrypted file portions (or “shards”; a digital asset may be divided manually or automatically into smaller pieces, portions, or shards, which may be encrypted before storage on the blockchain-based storage configuration) and may be verified one or more times, limiting the likelihood that a person has access to a previously sold book. An assembler may be configured to reconstruct or reassemble the file, and a validator may be configured to re-check/confirm the NFT ownership. Such a configuration helps to ensure sure that just in case the NFT is transferred, access of any of the store files may be disabled. The MIS may be configured to periodically check ownership for the media within a reading application on a device. For example, there may be instances where a device is disconnected from the internet, and the user has access to a textual digital asset such as a book, with the book text locally loaded on their computing device. In one exemplary scenario, on a secondary device, the user may sell the book still loaded on the original computing device. Once the original device is reconnected, the MIS may be configured to check ownership. If the ownership has changed, it may be configured to disable that user's access and delete those files pertaining to the book that is no longer owned or licensed by that user.

In the person-to-person exchange illustrated in FIG. 6C, a seller (“User 1”) lists a previously purchased book identified by its corresponding NFT for resale. And then the NFT gets purchased by a new user, “User 2”. While the person-to-person exchange is shown in FIG. 6C as distinct from the digital marketplace of FIG. 6B, an alternative implementation can result from integrating the person-to-person exchange into the digital marketplace. For example, the digital marketplace may have new copies of books available at retail prices, while resale copies of the same book at slightly lower prices. Once the purchase happens, line 606 may be followed from the person-to-person exchange of FIG. 6C to the MIS of FIG. 6B so that royalties and fees may be determined automatically in accordance with the smart contract. Once such determination is made, line 604 may be followed again because the book has changed hands paying appropriate royalties based on the smart contract back to the publisher and the author. Once the book resells, ownership may be transferred and verified on the blockchain, as previously described with reference to User 1 in FIG. 6B. For example, there may be periodic re-checks of media on User 2's device of ownership of the NFT.

This implementation also includes a reader software development kit (or “Reader SDK”) illustrated in FIG. 6B. In one implementation, this Reader SDK may be a software kit usable by various types of reader devices. For example, any one of the readers may be able to download and install the Reader SDK to unlock the appropriate content. In this way, the MIS may be utilized to control the infrastructure pertaining to how a book gets unlocked and read. In another alternative implementation, a portion of the Reader SDK may be provided as open-source software so that developers can create enhanced reading experiences.

The alternative book implementation of FIGS. 6A-6C also includes an anonymous marketing system, such as is illustrated in FIG. 6A. In this implementation, an author or publisher may create an instance of a digital asset such as a book, with an associated unique digital identifier, or NFT. Since the NFT may be stored on a blockchain-based storage system, the MIS may have the addresses, or locations, even as they get transferred back and forth because of sales or resales. More specifically, the line 608 in FIG. 6B may be followed back to the anonymous marketing system of FIG. 6A. This anonymous marketing system may be utilized to provide “direct push” style marketing to a user holding specific book titles in their library using the address associated with the NFT. Though direct, this marketing may be anonymous because it may be based on the wallet address for the NFT. For example, such an anonymous marketing system configuration may be utilized to send a marketing message to 10,000 people that have a specific book title. Individuals may be able to choose if they want to receive (or not receive) such marketing messages by adjusting the notification settings on their computing devices. With the anonymous marketing system configuration, authors and publishers can communicate directly with an end consumer. In addition, the anonymous marketing system configuration also may be utilized to provide rewards to users who meet select criteria, such as having a designated number of titles from a single author. Given the titles in a user's library, the anonymous marketing system may be configured to notify users when there may be a topic of interest, such as a book signing or new title by the same author. Such marketing system may also be configured to aggregate data across various authors within a single genre, for example.

The MIS shown in FIGS. 6A-6B may also be configured to include a book lending feature that provides a user access to a title for a limited time. For example, the smart contract deployed in FIG. 6B may designate that a user has access to a title for thirty days creating a set of instructions around the lending of the title. The MIS may be configured to periodically review and execute on the instructions as the varying conditions are satisfied. When the “return date” is met, the MIS may be configured to reassign the NFT from that user's wallet to a custodial user's wallet, or permanently disable the file contents for that NFT. This feature may be utilized to create a more efficient configuration for lending titles according to a set of conditions that are digitally managed. This feature facilitates libraries, schools, vendors, publishers, authors or other users in lending titles based on instructions they create and are executed by the MIS. In one alternative, the lending instructions may be fully customizable; in another alternative individuals may select from a group of lending instructions. Regardless, lenders may be assured that their titles will be according to the instructions they select.

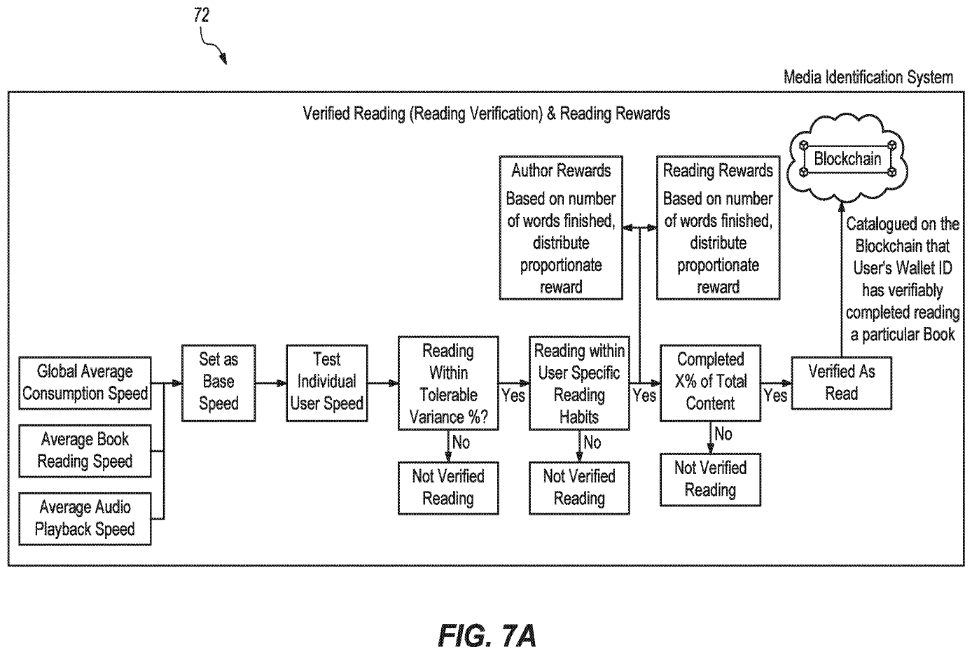

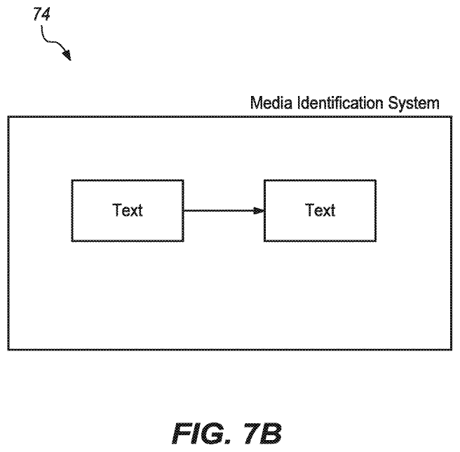

FIG. 7A illustrates another alternative implementation (72) of the MIS used in connection with books that includes a verified reading system applicable for either new or long-time users. This system may be configured to assess if people have read a book by considering speeds like the global average speed that a particular book is getting read, the specific average speed of that particular book, or the playback speed if it is an audio book. Such factors can form a base speed that may be tested against an individual user speed. This can be done, for example, by taking a tabulation determined by the number of words on a particular page divided by the time it takes a user to swipe or scroll off the page. This tabulation may be utilized to determine the individual user speed in words per minute, along with a tolerable variance around that speed. The verified reading system then may be configured to determine if a user's reading speed is either inside or outside of the tolerable variance. If it is not within the tolerable variance, the “no” path may be followed and it is not verified as read. If it is within the tolerable variance, the “yes” path may be followed to determine if a threshold amount of the content, such as 85%, has been completed. If that amount of the content has not been completed, the “no” path may be followed, and the reading is not verified. If the threshold amount has been completed, the “yes” path may be followed, and the book may be verified as read. The MIS may be configured to update a user's electronic wallet on the blockchain storage showing that a particular book has a status of “read”. Another implementation of the verified reading system may be configured to provide rewards that either an author or a reader may receive. For example, a user may receive 10 points every time 1000 words are read meaning that the user would incrementally accumulate 200 points for a book with 20,000 words, which also can be updated to the blockchain using the NFT. The verified reading system, whether used with rewards or not, may be utilized to help instructors across a variety of sectors determine if students have read assigned content and help identify experts who have read a large percentage of books on a particular topic.

FIG. 7B illustrates another alternative implementation (74) of the verified reading system that includes a book recommendation system inside the MIS. Using unique digital identifiers or NFTs, the MIS may be configured to determine that a user has these specific 10 books in her digital library, and then recommend the next book for purchase using information about books other users with similar books in their digital library have. For example, there may be 500 people who have 90% of the ten books a user possesses. The MIS may be configured to consider not simply whether an individual has the book in the library, but also look at the reading completion percentage for the 500 people of the books distinct from the user's library and make recommendations accordingly.

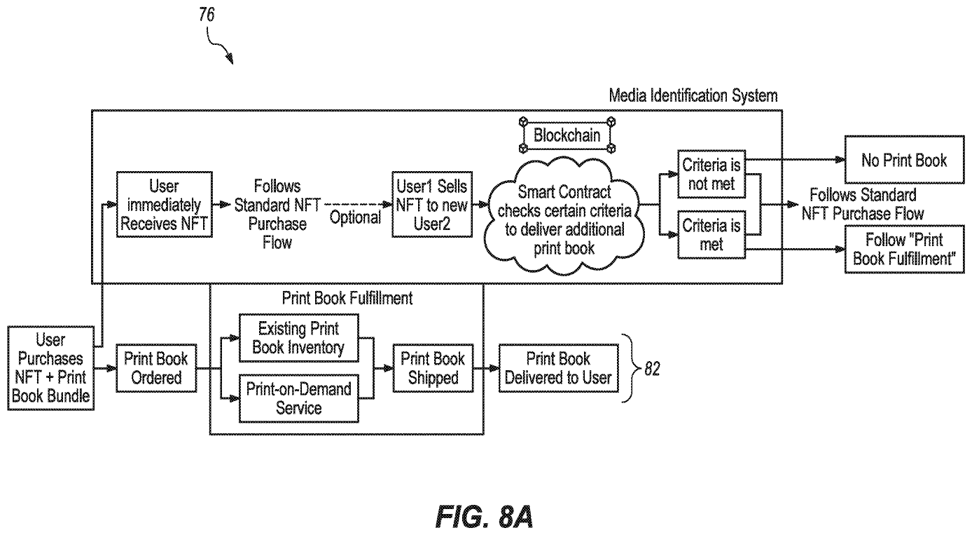

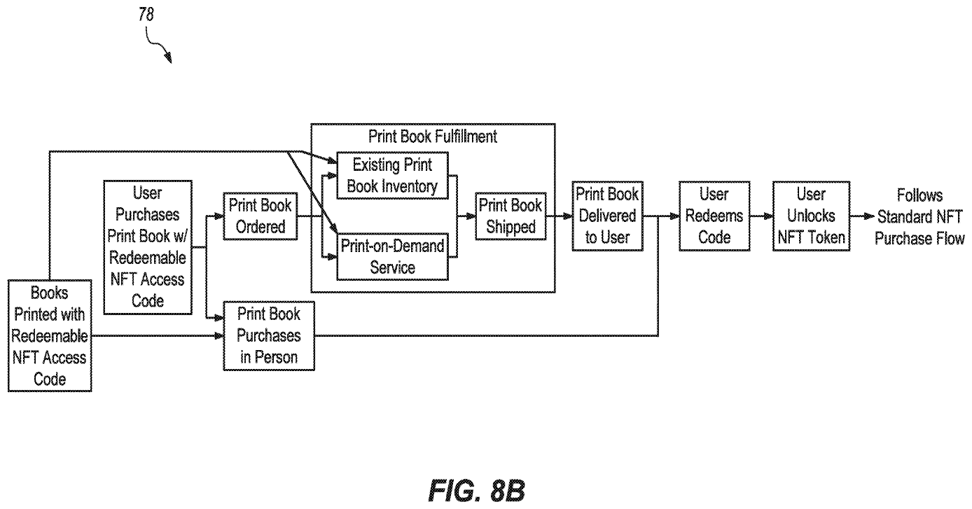

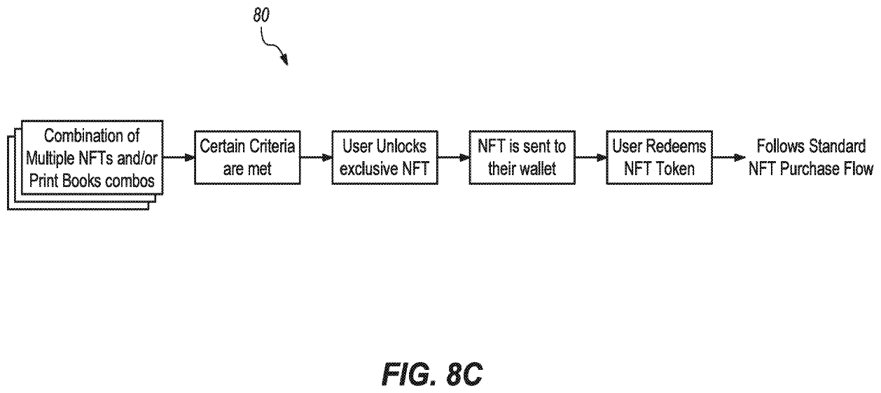

FIGS. 8A-8C illustrate additional implementations of the MIS used in connection with a print digital bundles of digital assets. For example, referring to FIG. 8A, a configuration (76) is illustrated wherein a user may purchase a digital copy of a book by purchasing the copy's unique digital identifier, or NFT. This purchase may create a print fulfillment path shown in the lower portion (82) of FIG. 8A wherein a printed copy of the book may be ordered, printed, and delivered to the user. Within the print book fulfillment path, there may be a check to determine whether the book already exists. If the book does not exist in print already, it may be printed on demand for delivery to the user. The purchase also may be utilized to create a parallel digital flow that functions as a digital fulfillment path where the user receives the purchased NFT and follows a flow like the ones described in FIGS. 6B-6C until the point of the User 1 sells the digital copy, or NFT, to User 2. At this point, the MIS may review the smart contract for this digital copy and determines whether designated criteria have been met. For example, a digital-print bundle may be configured to have criteria specifying that a printed book is sent to the new user every time a digital copy is sold for 75% of the retail value; a printed book is sent for the first 100 prints only; or that the printed book is only sent for the original purchase and no subsequent purchases. Thus, the MIS may be configured to send a request to order the printed book when appropriate.

FIG. 8B illustrates a second alternative implementation (78) of a digital print bundle for the MIS. Referring to FIG. 8B, a first user purchases a printed book at a point-of-sale location, for example, with a redeemable code to access the NFT. Alternatively, “user 1” could order from the seller's website a printed copy of the book triggering the print fulfillment flow, as described with reference to FIG. 8A. However, the printed copy would include a redeemable code to access the NFT, or digital copy of the book. If a user redeemed the code using this system, the user would have acquired the NFT, and the flows described with reference to FIGS. 6A-6B can be followed.

Referring to FIG. 8C, a third alternative implementation (80) of a digital print bundle for the MIS is illustrated. In this implementation a user may purchase a collection, which may be specifically defined. For, example it may be all the books by a specific author, a specified number of books, or a designated number of print and digital books. Regardless of how the collection is defined, the MIS may be configured to assess whether a user has met the collection criteria, by using a smart contract for example. When it determines that the criteria has been met, the MIS may be configured to reward the user with another NFT, which may be exclusive content (such as a textual note, or other digital asset such as an audio or audio-video asset of limited access) not available to the public. For example, the exclusive or special content may comprise a personally signed print copy of the title, a limited-edition book, or some other collector's item. Regardless of the approach, the MIS may be configured to add the reward NFT to the user's wallet, making it another item the user owns or has license to, and may be able sell in a digital marketplace, if desired and/or appropriate. Thus variations are disclosed in reference to FIGS. 1-8C wherein a media identification system may address various digital rights marketplace objectives. For example, a subject system may comprise one or more computing devices configured to analyze digital media, separate content data from other data, encrypt certain content data, separate graphical data from other data, upload encrypted content data to a decentralized blockchain storage configuration, upload graphical data to a decentralized blockchain storage configuration, define certain smart contract terms, and create one or more unique media identifiers.

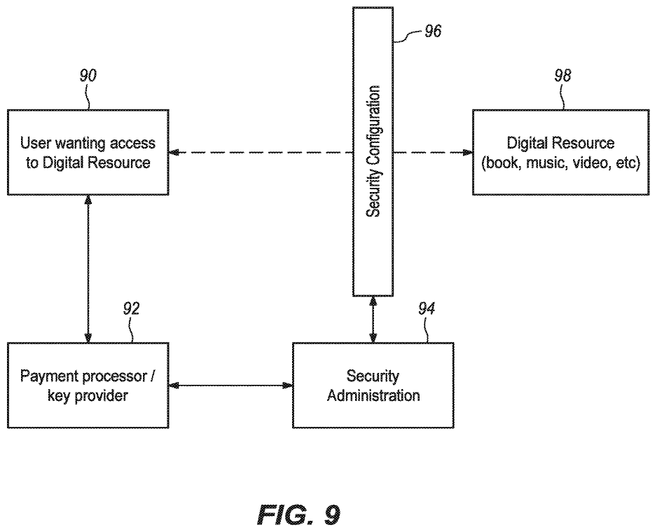

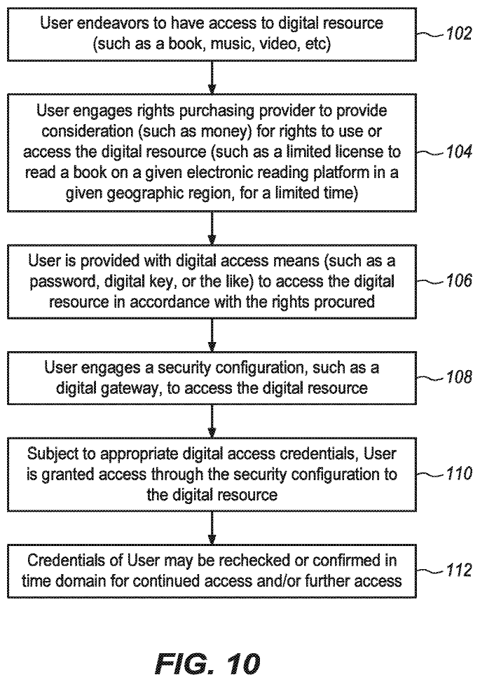

Referring to FIGS. 9 and 10, a general paradigm of digital rights access is illustrated wherein a user wants access to a digital resource (90), such as a textual digital asset, a graphic or artistic digital asset, an audio digital asset, and/or a audio-video digital asset but must pass through some gateways or hurdles to obtain the rights and access. For example, as noted above, generally some consideration must be provided, such as payment (92) to a processor which may provide one or more forms of access keys, such as digital asset keys. Such keys may also be administered by a security administration (94) function which may control an access gateway or security configuration (96) designed to prevent access to the digital resource or asset (98) until all requisite hurdles are met and confirmed. Thus a typical flow, as shown for example in FIG. 10, may begin with a user wishing to have access to a digital resource (102). The user may engage a rights purchasing provider to provide consideration, such as money, in exchange for rights (such as limited license rights which may be limited by various factors such as time, region, computing device, and the like) to use or access the digital resource (104). Given a successful exchange, the user may be provided with digital access means, such as a password, digital key, or other gateway pass or privileges confirmation to gain appropriate access to the digital resource (108). Subject to appropriate credentials, the user may be allowed across the security configuration to gain such access (110), and the credentials and other details pertaining to the user (such as identification confirmation) may be confirmed from time to time for continued or further access (112).

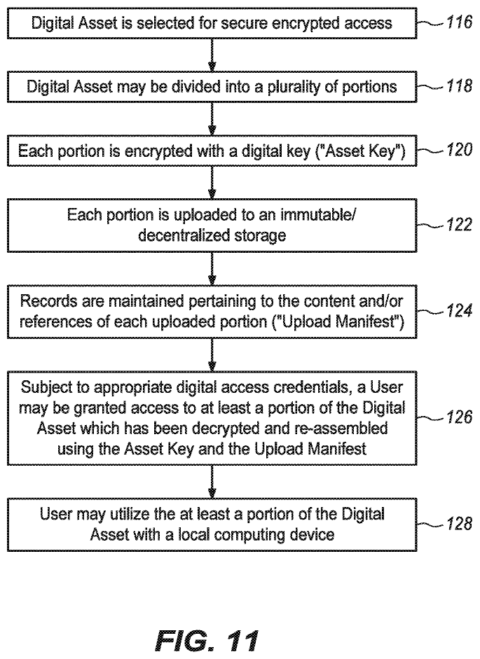

Referring to FIG. 11, as noted above, with the continued development and evolution of decentralized storage technologies, such as peer-to-peer filing sharing systems which may be immutable, persistent, secure, and based upon blockchain configurations, there is an opportunity to provide an enhanced level of secure access to selected digital assets. As shown in FIG. 11, a digital asset may be selected to be made available on an exchange or access system configured to feature certain digital assets in a secure manner using asset encryption (116). To produce a so-called “digital encrypted asset”, or “DEA”, for the illustrated exchange configuration, the selected digital asset may be divided into a single portion, or a plurality of portions (118). Each portion may be encrypted with a digital key (which may be termed an “Asset Key”) (120), and each encrypted portion may be uploaded to an immutable/decentralized storage configuration, such as a blockchain-based peer-to-peer decentralized filing sharing system (122). Records may be maintained pertaining to the content and/or references of each uploaded portion (in what may be termed an “Upload Manifest”) (124), resulting in secure, encrypted storage of the subject digital asset. Referring again to FIG. 11, subject to appropriate digital access credentials, a user may be granted access to at least a portion of the targeted digital asset which has been decrypted and re-assembled using the Asset Key and the Upload Manifest (126). The user may utilize the at least a portion of the targeted digital asset with a local computing device, such as a digital book reader or digital music player (128).

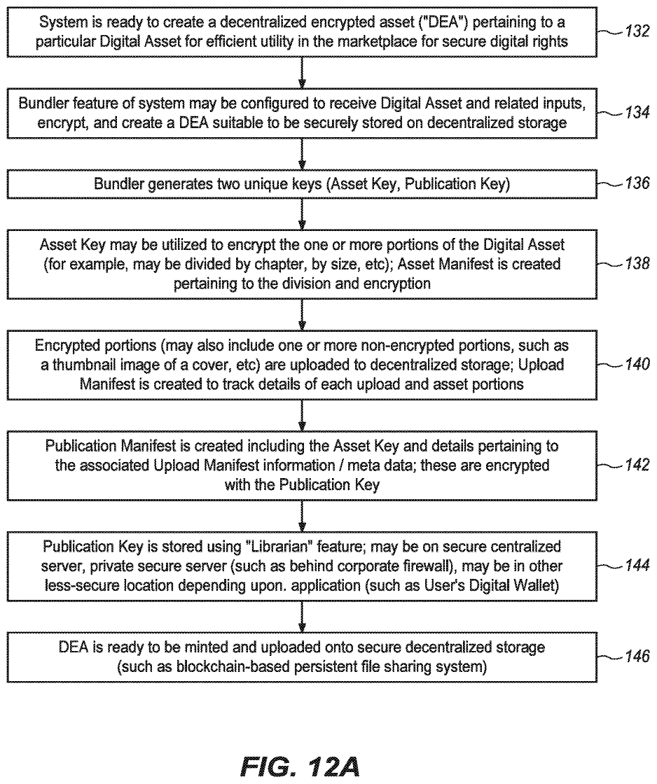

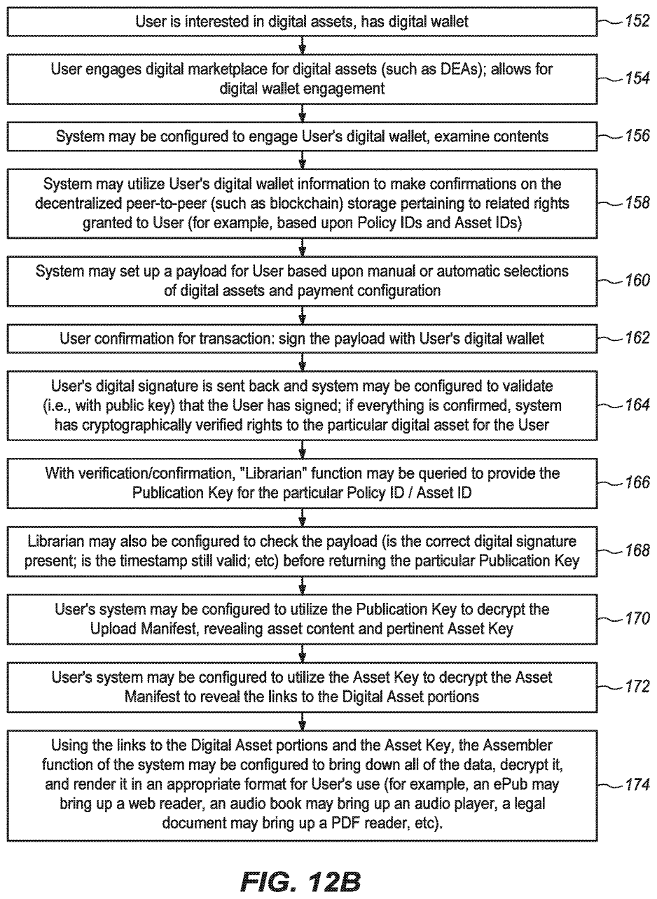

Referring to FIGS. 12A and 12B, an embodiment similar to that of FIG. 11 is illustrated, with further processing detail pertaining to various steps pertinent to such embodiment.

Referring to FIG. 12A, a computing system may be ready to create a decentralized encrypted asset (“DEA”) pertaining to a particular Digital Asset for efficient utility in the marketplace for secure digital rights (132). A “Bundler” feature of system may be configured to receive Digital Asset and related inputs (for example, such as a ePublication or eBook document pertaining to a textual digital asset, perhaps along with one or more images pertaining to an artistic cover for the digital asset; these inputs may comprise a self-contained web page or .ZIP file, for example), encrypt, and create a DEA suitable to be securely stored on decentralized storage such as a blockchain-based peer-to-peer decentralized filing sharing system (134). The Bundler may be configured to generate, such as by using a pre-existing algorithm, two unique keys, an Asset Key and a Publication Key, both of which may comprise a strong of characters configured to be specific to a unique encryption code (136). The Asset Key may be utilized to encrypt (138) the one or more portions of the subject Digital Asset (for example, may be divided by chapter, by size, such as predetermined portion size, etc; the system may be configured to automatically make such divisions into portions; may also remain as a single portion, depending upon the storage configuration and capability pertaining to latency, throughput, and other desirable operational factors), and an “Asset Manifest” may be created pertaining to the division and encryption. As noted above, the subject Digital Asset may be divided by the associated computing system by size, such as by a predetermined file portion size, by chapters, as in the division often made by creators of works such as textual digital assets such as books, by geometric portions, such as in the case of an artistic visual digital asset such as an image of a painting or photograph, and/or by sequential portion, such as with different musical pieces on a given recorded music album audio asset. The portions may be manually or automatically selected/divided, and may be termed names such as “shards”, “spines”, or “spine portions” to be encrypted before upload. The encrypted portions (may also include one or more non-encrypted portions, such as a thumbnail image of a cover, etc) may be uploaded to decentralized storage such as a blockchain-based peer-to-peer decentralized filing sharing system (such as that available under the tradename IPFS® or InterPlanetary File System®), and an “Upload Manifest” document or file may be created, encrypted (such as with the Asset Key), and stored to track details of each upload and asset portions (140). A “Publication Manifest” may be created including the Asset Key and details pertaining to the associated Upload Manifest information/meta data; these may be encrypted with the Publication Key (142). The Publication Key may be stored using a “Librarian” feature, which may have such Publication Key being stored in various forms, such as on a secure centralized server, on a private secure server (such as behind corporate firewall), or in another less-secure location depending upon the particular application (such as on User's Digital Wallet), for example (144). With the preceding steps completed, the DEA may be certified ready to be minted and uploaded onto secure decentralized storage (such as blockchain-based persistent peer-to-peer file sharing system) (146).

Referring to FIG. 12B, various elements of an access embodiment configuration are illustrated to facitating user access to a decentrally-stored DEA as described above. Referring back to FIG. 12B, a user may have a desire or need to utilize digital assets, and may have a digital wallet available (152). The user may engage a computer-based digital marketplace for digital assets (such as DEAs), and the marketplace and user may approve or allow for digital wallet engagement (154). The system may be configured to automatically engage the user's digital wallet and examine contents (156). The system may be configured to utilize the user's digital wallet information to make confirmations on the decentralized peer-to-peer (such as blockchain) storage pertaining to related rights granted to User (for example, based upon particular Policy IDs and Asset IDs associated with given digital assets) (158). The system may be configured to set up a payload for the user based upon manual or automatic selections of digital assets (for example, manual, recommended, or automatic selection of various books, music, and the like, depending upon configurable user settings) and appropriate payment configuration (160). The user may be required to provide a confirmation or digital signature pertaining to the subject payload using the user's digital wallet (162). The user's digital signature may be sent back and the system may be configured to validate (i.e., with public key) that the User has signed; if everything is confirmed, the system has cryptographically verified rights to the particular digital asset for the user (164) and a “Librarian” function may be queried to provide the Publication Key pertaining to the particular Policy ID/Asset ID germane to the particular asset of interest (166). Still referring to the embodiment of FIG. 12B, the Librarian function may also be configured to check the payload (is the correct digital signature present; is the timestamp still valid; for example) before returning the particular Publication Key (168). The user's local computing system (which may be termed a “client” computing system; may be a personal computing device such as a smartphone, laptop computer, smart watch, smart television, tablet computer, media reader, or many other computing devices, as noted above) may be configured to utilize the Publication Key to decrypt the Upload Manifest, revealing asset content and pertinent Asset Key (170). The user's local computing system may be configured to utilize the Asset Key to decrypt the Asset Manifest to reveal the links to the Digital Asset portions (172). Finally, using the links to the Digital Asset portions and the Asset Key, the “Assembler” function of the system may be configured to bring down all of the data, decrypt it, and render it in an appropriate format for user's use on the user's local computing system (for example, an ePub may bring up a web reader, an audio book may bring up an audio player, a legal document may bring up a PDF reader, etc). Various operative couplings between systems and components thereof may be conducted using network connections such as wired or wireless network connections, such as via IEEE 802.11 types of connections, smartphone-style mobile telecom connectivity, fiber or copper terrestrial lines, and the like. Decentralized computing assets may be co-located or not-co-located, depending upon security, latency, and integration factors, for example.

Another embodiment is directed to a secure system for providing limited access to purchasing interface, comprising a client computing system local to a user and configured to display a graphical user interface configured to facilitate operation of a purchasing digital asset; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, the purchasing digital asset may be securely reassembled by the client computing system operated by the user such that the user may operate the purchasing digital asset to consummate a purchase which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the purchasing digital asset into a plurality of portions based upon a predetermined portion size. A computing device may be configured to automatically divide the purchasing digital asset into a plurality of portions. The purchasing digital asset may comprise a purchasing graphical user interface comprising an order and payment configuration. The purchasing digital asset may comprise an event ticket purchasing interface. The purchasing digital asset may comprise a limited-quantity-goods/services purchasing interface. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted. The purchasing digital asset may be securely reassembled by the client computing system operated by the user only subsequent to presentation of both the asset key and the manifest document.

Another embodiment is directed to a secure system for providing limited access to a digital asset, comprising a client computing system local to a user and configured to display a graphical user interface configured to facilitate utilization of a digital asset after successfully meeting a pre-established condition precedent; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key, and the manifest document, and upon confirmation that the pre-established condition precedent has been met, the digital asset may be securely reassembled by the client computing system operated by the user such that the user may operate the graphical user interface to utilize the digital asset, which would otherwise be unaccessible. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The digital asset may comprise a limited-access artistic image. The digital asset may comprise a limited-access video recording. The digital asset may comprise a limited-access audio recording. The digital asset may be customized for the user. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a secure system for providing location-based limited access to a digital asset, comprising a client computing system local to a user in a user location and configured to display a graphical user interface configured to facilitate utilization of a digital asset; and a decentralized peer-to-peer file sharing system operatively coupled to the client computing system and configured to facilitate assembly and use of the purchasing digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the user location, the digital asset may be securely reassembled by the client computing system operated by the user in a delivery configuration based at least in part upon the user location. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. Information pertaining to the user location may be selected from the group consisting of: client computing system localization information; user address location information; and user-volunteered location information. Information pertaining to the user location may comprise client computing system localization information determined, based at least in part, upon an input from the group consisting of: GPS information; network triangulation information; network address information; and wireless transceiver triangulation information. The digital asset may be securely reassembled by the client computing system operated by the user in a delivery configuration in a specific form based upon the user location. The digital asset may be securely reassembled by the client computing system operated by the user in a delivery configuration with specific content based upon the user location. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Another embodiment is directed to a secure system for providing connectivity-based limited access to a digital asset, comprising a client computing system local to a user in a user location and configured to display a graphical user interface configured to facilitate utilization of a digital asset through a network connection; and a decentralized peer-to-peer file sharing system operatively coupled to the client computing system through the network connection and configured to facilitate assembly and use of the digital asset which has undergone a sequence of division into portions, encryption of each of the portions using an asset key, storage of the portions on the peer-to-peer file sharing system after encryption, and creation of a manifest document based upon the division, encryption, and storage; wherein upon presentation of the asset key and the manifest document, along with information pertaining to the quality of the network connection, the digital asset may be securely reassembled by the client computing system operated by the user in a delivery configuration based at least in part upon the quality of the network connection. The client computing system may comprise a personal computing device. The personal computing device may be selected from the group consisting of: a smartphone, a personal computer, a tablet, a media reader, a smart watch, a television set-top computing system, and an integrated smart television. The client computing system may be operatively coupled to the decentralized peer-to-peer file sharing system using a network connection. The network connection may be a wired or wireless network connection. A computing device may be configured to divide the digital asset into a plurality of portions based upon a predetermined portion size. A computing device may be configured to automatically divide the digital asset into a plurality of portions. The quality of the network connection may be determined based at least in part upon an input from the group consisting of: a network latency determination; a packet loss determination; a bandwidth determination; a network route-trace determination, and a signal strength determination. The quality of the network connection may be determined using an automated testing paradigm during at least a portion of the time during which the client computing system is operatively coupled to the decentralized peer-to-peer file sharing system. The digital asset may be securely reassembled by the client computing system operated by the user in a delivery configuration utilizing a digital asset resolution that is dynamic to the quality of the network connection. The digital asset may be securely reassembled by the client computing system operated by the user in a delivery configuration utilizing a digital asset transmission rate that is dynamic to the quality of the network connection. The digital asset may be securely reassembled by the client computing system operated by the user in a delivery configuration utilizing a digital asset buffering configuration that is dynamic to the quality of the network connection. The asset key may comprise a string of bits configured to be specific to a unique encryption code. The asset key may comprise a string of characters configured to be specific to a unique encryption code. The asset key may be created using a pre-existing algorithm. The decentralized peer-to-peer file sharing system may comprise a plurality of file sharing subsystems that are not co-located. The decentralized peer-to-peer file sharing system may comprise a plurality of file sharing subsystems configured to be immutable. The decentralized peer-to-peer file sharing system may comprise a blockchain-based persistent file sharing system. The manifest document may be configured to contain meta data pertaining to the content of the encrypted portions. The manifest document may be encrypted.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A system for providing secure access to a digital asset, comprising:
A. a client computing system local to a user and configured to display a graphical user interface configured to facilitate reading of one or more textual features of the digital asset; and
B. a decentralized peer-to-peer file sharing system operatively coupled to the client computing system and configured to facilitate assembly and use of the textual digital asset which has undergone a sequence of division into portions, encryption of each of the portions using an asset key, storage of the portions on the peer-to-peer file sharing system after encryption, and creation of a manifest document based upon the division, encryption, and storage;
wherein upon presentation of the asset key and the manifest document, the textual digital asset may be securely reassembled by the client computing system operated by the user such that the user may sequence through the one or more textual features of the textual digital asset.

2. The system of claim 1, wherein the client computing system comprises a personal computing device.

3. The system of claim 2, wherein the personal computing device is selected from the group consisting of: a smartphone, a personal computer, a tablet, a media reader, and a smart watch.

4. The system of claim 1, wherein the client computing system is operatively coupled to the decentralized peer-to-peer file sharing system using a network connection.

5. The system of claim 4, wherein the network connection is a wired or wireless network connection.

6. The system of claim 1, wherein a computing device is configured to divide the textual digital asset into a plurality of portions based upon a predetermined portion size.

7. The system of claim 1, wherein a computing device is configured to automatically divide the textual digital asset into a plurality of portions.

8. The system of claim 1, wherein a computing device configured to divide the textual digital asset into a plurality of portions based upon chapters in the textual digital asset created by an author of the textual digital asset.

9. The system of claim 8, wherein the computing device is configured to divide the textual digital asset by chapters.

10. The system of claim 1, wherein the asset key comprises a string of bits configured to be specific to a unique encryption code.

11. The system of claim 1, wherein the asset key comprises a string of characters configured to be specific to a unique encryption code.

12. The system of claim 1, wherein the decentralized peer-to-peer file sharing system comprises a plurality of file sharing subsystems that are not co-located.

13. The system of claim 1, wherein the decentralized peer-to-peer file sharing system comprises a plurality of file sharing subsystems that are not co-located.

14. The system of claim 1, wherein the decentralized peer-to-peer file sharing system comprises a plurality of file sharing subsystems configured to be immutable.

15. The system of claim 14, wherein the decentralized peer-to-peer file sharing system comprises a blockchain-based persistent file sharing system.

16. The system of claim 1, wherein the manifest document is configured to contain meta data pertaining to the content of the encrypted portions.

17. The system of claim 1, wherein the manifest document is encrypted.
